(19) United States
(12) Patent Application Publication
(10) Pub. No.: US 2004/0043206 A1
(43) Pub. Date: Mar. 4, 2004

(54) Self-forming polymer composites

(76) Inventors: Stephen F Bush, Cheshire (GB); James M Methven, Wirral (GB); David R Blackburn, Cheshire (GB); Annette J. Neuendorf, Canberra (AU)

Correspondence Address: BURNS DOANE SWECKER & MATHIS L L P, POST OFFICE BOX 1404, ALEXANDRIA, VA, 22313-1404, US

(21) Appl. No.: 10/380,073

(22) PCT Filed: Sep. 10, 2001
(86) PCT No.: PCT/GB01/04032

(30) Foreign Application Priority Data
Sep. 11, 2000 (GB) 00221838

(51) Int. Cl. B29C 61/02; B29C 71/02

(52) U.S. Cl. 428/297.4; 264/230; 264/345

(57) ABSTRACT

Polymer composites are comprised of a polymer matrix incorporating heat shrinkable fibres disposed within the matrix to render the composite self-thermally forming. The composite may be an elongate article or a sheet or plate. Application of heat, e.g. —localised heating, causing shrinkage of the fibres with self-thermal forming of the composite.

The present invention relates to polymer composites and more particularly polymer composites which may be shaped relatively easily into a desired form.

Polymer composite materials are comprised of a polymer matrix (consisting of either a thermoplastic or a thermoset) incorporating reinforcing fibres. Many manufacturing methods for such materials exist; examples of which include extrusion, pultrusion, compression moulding and so on. The final choice of process is determined by both the materials and the desired form of the component itself. In some cases more than one stage is adopted in production, as with the forming so-called pre-pegs for compression moulding.

The final shaping polymer composites is typically achieved by pressing or forming the material against or through a mould, former or die. The polymer matrix is cooled or cured into a solid form and final product consequently retains the shape. Subsequently (at least in the case of a mould or former) the product needs to be removed therefrom. It will be appreciated that the capital outlay for such moulds, formers and due may be considerable. Furthermore they suffer from the disadvantage of the time taken for removing the final product which adds to the overall cost thereof.

It is an object of the present invention to provide polymer composites that obviate or mitigate the above-mentioned disadvantages and in particular lend themselves to economical shaping operations.

According to a first aspect of the present invention there is provided a polymer composite comprised of a fibre or fibres in a polymer matrix wherein the or at least a portion of said fibres are heat shrinkable and is/are disposed within the matrix to render the composite self-thermally forming.

By “self-thermally forming” we mean that heating of the composite above a predetermined temperature will cause the composite to adopt or retain a different shape configuration as compared to that which would be adopted by an unrestrained form of the composite below that temperature. Thus, by way of example (as will be appreciated from the more detailed description given below) the step of self-thermal formation may be effected by heating an unrestrained form of the composite to above a predetermined temperature so as to cause the composite to change shape into a predetermined form. Alternatively the self-thermally forming composite may physically be bent (or otherwise mechanically configured) into a particular shape which is then heated to above the predetermined temperature. Above this temperature the composite is capable of holding this shape without restraint. It will be clear that the self-thermal formation step (to produce a desired shape configuration from the polymer composite) may be effected simply by heating and avoids the need for expensive moulds, formers or dies. According to second aspect of the present invention there is provided a method of forming a shaped product comprising heating a polymer composite comprised of a polymer matrix incorporating at least one heat shrinkable fibre disposed within the matrix so as to render the composite self-thermally forming, said heating being effected in at least a region of set composite so that the composite self-thermally forms to produce the shaped product.

Key to the invention are the heat shrinkable fibres provided in the composite and which are located therein so that the composite is self-thermally forming (as described above) due to the shrinkage of the fibres on heating above a predetermined temperature depending on the particular heat shrinkable fibres used. More particularly, the location of the heat shrinkable fibres within the composite material will be such, that on heating of the fibres, their contraction is able to generate in the material a force which causes deformation of the polymer matrix so that the composite material adopts a new shape.

The heat shrinkable fibres will generally by continuous and generally also will extend from an end of the article to an opposite end thereof.

Self-thermally forming composites in accordance with the invention may take a number of physical forms. The cross-section of the composite can with advantage be configured so as to enhance the extent to which the composite changes shape on heating.

The composite may for example be in the form of an elongate article in which the heat shrinkable fibres extend axially of the article (usually but not necessarily along the entire length thereof). In such elongate articles (which may, for example, be pultrudates) the thermally shrinkable fibres may be provided offset from the axial centre line of the article. The elongate article may for example be of square, rectangular, triangular or other polygonal cross-section with the heat shrinkable fibres being provided at or just inwardly of a side of the article (as viewed in cross-section). If the article is of rectangular cross-section then the heat shrinkable fibre or fibres may be provided just inwardly of either the short side or the long side of the rectangle.

Alternatively the elongate article may be of circular, oval, elliptical or similar cross-section with the heat shrinkable fibres being provided just inwardly of the circumference of the cross-section at one side thereof.

Heating of a straight length of such elongate articles over its entire length will generally cause the length to adopt an arcuate configuration.

As an alternative to the elongate articles described above, the composite of the invention may for example be in the form of a sheet or a plate. In this case, the heat shrinkable fibres will be provided closer to one major face of the sheet or plate than the other.

It will be appreciated that the shape of composite materials in accordance with the invention may easily be modified simply by heating of the material. The whole material may be heated or alternatively only a localised region thereof, depending on the particular change in configuration desired. Thus, for example, in the case of the elongate articles described above, localised heating (e.g. by a jet of hot air) may cause the article to adopt an angled configuration whereas heating a full length of the article may cause the latter to adopt an arcuate configuration. As indicated above, such shaping operations avoid the need for expensive moulds, formers or dies. The shaping operation may, in fact, be effected simply by locating the composite article, or a succession of such articles, on a belt which travels through or past a source of heat (e.g. a hot air jet directed at a particular point on the article) for effecting the change in shape configuration. After the change has occurred, the shaped product may simply be removed from the belt thus avoiding not only the disadvantage of expensive moulds, formers or dies but also the relatively time consuming operation of removing the final product from a mould which adds to the overall cost of the product. Additionally the sources of heat used (e.g. a jet of hot air) are relatively cheap.

It will be appreciated that sheets or plates may be processed in a similar manner to produce articles of the desired configuration.

The self-thermally formed products are capable of recovering their shape after loading.

The polymer matrix may be a thermoplastic or thermosetting resin. If the latter then the temperature of which the resin cures should be above the temperature of which shrinkage of the fibres occurs so that thermoforming occurs before the final curing.

Examples of thermoplastics that may be used include polyolefins, e.g. polyethylene and polypropylene. Further examples include polyamides, e.g. nylon. Examples of thermosetting resins include unsaturated polyesters, polyurethanes, uracrylates, and vinyl esters.

Generally the heat shrinkable fibres will be such that shrinkage occurs in the temperature range 40° to 250° C. (e.g. 100° to 200° C.) although we do not preclude the use of fibres where shrinkage occurs at a temperature outside the range.

The heat shrinkable fibres to be incorporated in the composite are preferably such that they shrink by at least 30% of their length when heated above the predetermined temperature. A shrinkage value in the range 30% to 60% will generally be particularly suitable.

The fibres may for example be in the form of a tow comprised of a plurality of strands each themselves formed of a multitude of continuous filaments. These continuous filaments may be drawn filaments and have a draw ratio such they have the shrinkage values discussed above.

The heat shrinkable fibres preferably have an average cross-section equivalent to 500 to 1500 tex, e.g. 100 tex, for the fibres used.

Preferred heat shrinkable fibres for use in the invention are polyester fibres, most preferably polyethylene terethalate (PET) fibres. The polyester fibres are preferably used in the form of a tow as described above and preferably have a low or non-oil surface. A suitable PET fibre is one available under the code number CN 3-167-34 (which designates a tow having 3 strands each having a decitex value of 167 and each comprising 34 filaments.

The composite of the invention may incorporate a first type of heat shrinkable fibre for which shrinkage occurs at a first temperature and a second type of such fibre for which shrinkage occurs at a second, higher temperature. Depending on the location of these fibres in the composite, heating to the first temperature will cause a first change in shape configuration to occur and subsequently heating to the second (higher) temperature will cause a second change to occur. Thus, consider, for example, an elongate article incorporating suitably disposed first and second fibres. Heating to the first temperature may cause the article to adopt an accurate form and heating to the second temperature may cause the ends to bend round in the opposite sense. Heating of the composite to effect the accurate form may for example be effected in an oven and heating to bend the ends in the opposite sense may be effected by hot air jets. In this way shapes that are difficult to produce by other methods are easy to obtain.

As a development if the arrangement described in the previous paragraph the composite may incorporate further heat shrinkable fibres which shrink above the shrinkage temperature of the second fibres thus allowing even more complex shapes to be produced.

In an advantageous embodiment of the invention, the composite also incorporates fibres which exhibit no or less shrinkage on heating above the temperatures causing shrinkage of the heat shrinkable fibre. For convenience we shall refer to the fibres that have no (or the lesser) shrinkage characteristics as “retaining fibres”. These “retaining fibres” are positioned within the composite such that thermoforming may occur as previously described but they resist recovery on cooling so that the thermoformed shape is retained. The “retaining” fibres will generally by continuous and generally also will extend from an end of the article to an opposite end thereof. The “retaining fibres” may for example have a Youngs Modulus of 3 to 80 GPa (e.g. 20 to 40 GPa) and an average cross-section equivalent to of 150 to 1000 tex, e.g. 150 to 700 tex, for the fibres used.

Examples of suitable retaining fibres includes textile fibres of natural or synthetic origin (e.g. cotton, linen, flax, etc), carbon fibres, aramid fibres, polyolefin fibres and glass fibres. If the polymer matrix of the composite is polypropylene then cotton is a suitable “retaining fibre”.

The “retaining fibres” may be provided along an opposite side of the composite to that at which the heat shrinkable fibres are provided. The “retaining fibres” may also be provided alongside or the adjacent to the heat shrinkable fibres.

Although there are many instances where it is desired to retain the shape resulting from self-thermal formation (for which purpose the aforementioned “retaining fibres” may be provided) the invention also contemplates articles where the self-thermal formation is reversible. Thus heating the article above the predetermined temperature causes a change from the original shape configuration whereas cooling below that temperature causes the article to revert to its original shape. Such an article would, for example, be the polymer composite equivalent of a bimetallic strip or a shaped memory metal alloy.

Composite articles in accordance with the invention may for example comprise 1% to 60%, but more preferably 5% to 20%, by volume of fibres (i.e. heat shrinkable fibres and “retaining fibres”, if present).

It should be ensured that the fibres are suitably coupled to the polymer matrix. This may be achieved by the use of a coupling agent which in the case of the polypropylene matrix may, for example, be a maleic anhydride tipped polypropylene. A suitable coupling agent for use with polypropylene is available under the Trade Mark POLYBOND.

Factors which influence the change in shape that is generated on heating of the composite material include the nature of the polymer matrix, the, nature and positioning of the heat shrinkable fibres, the presence and positioning of “retaining fibres”, temperature of heating, time of heating, and nature of heating (e.g. localised). Thus by appropriate selection of the parameters it is possible to achieve a wide range of effects, including the use of two or more heating temperatures (possibly applied at different locations) to produce products of relatively complicated shape.

Final products may be formed from a plurality of self-thermally forming composites (e.g. elongate strips) and optionally also composites (or other materials) that do not self-thermally form. To produce such products, the self-forming composites and non-forming materials (if used) are initially assembled into a particular configuration and optionally heat fused together (at a temperature below that at which self-thermal formation occurs) under light pressure. Subsequently the assembled configuration is subjected to heating as necessary so that individual composites of the invention self-thermally form to provide the desired final product. For the purposes of producing such products, it is possible to use a number of different types of composites in accordance with the invention that self-thermally form at different temperatures Additionally any one of the composites (of the invention) may self-thermally form at two different temperatures (as outlined above). It would therefore be appreciated that many different combinations are possible allowing a variety of complex final products (that would be difficult, if not impossible to be produced by other methods) to be obtained by the simple step of hearing at the appropriate temperature(s).

By way of example, self thermally forming elongate articles (e.g. pultrudates) as described above may be used for the formation of cage structures by laying the thermoformable elongate articles in one direction and either further self-thermally forming articles, non-self thermally forming articles or a combination of such articles in the cross ways direction to produce a criss-cross arrangement which (after optional preliminary heat fusing of the elements together e.g. under light pressure) is then heated to produce the desired structure

### The invention will he illustrated by the following non-limiting Examples and accompanying drawings, in which:

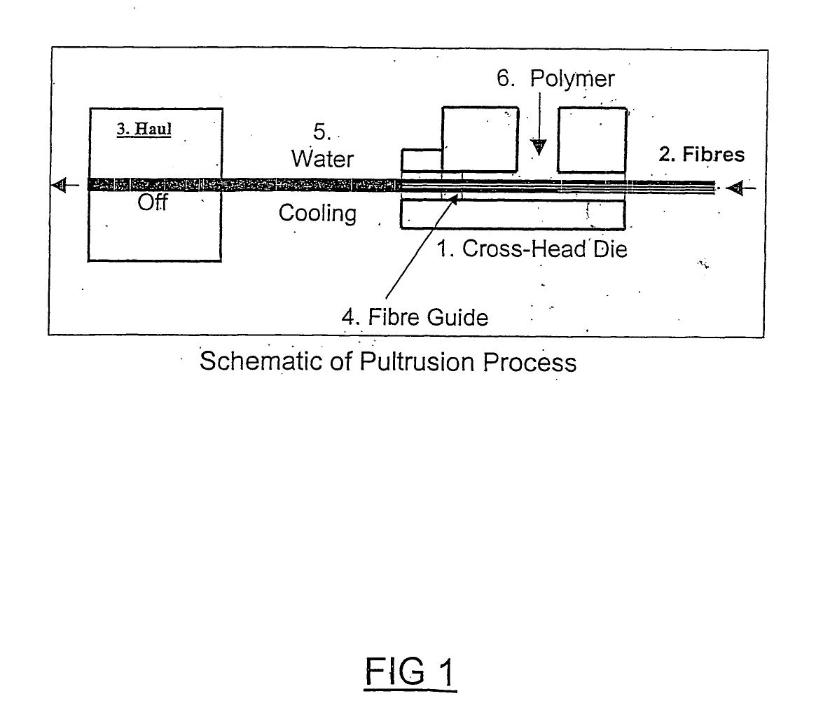

FIG. 1 schematically illustrates production of a polymer composites in accordance with the invention; and

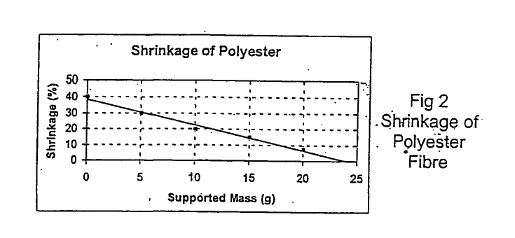

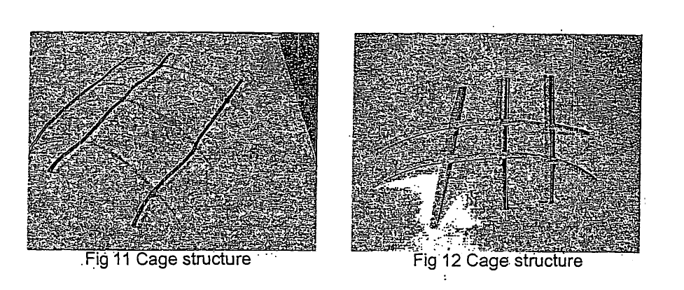

FIGS. 2 to 13 relate to the Examples.

FIG. 1 schematically illustrates a conventional pultrusion process which may be applied to the production of pultrudates in accordance with the invention. In the illustrated process there is a cross-head die 1 through which fibres 2 are pulled by a haul-off device 3 Within the cross-head die 2 is a fibre guide 4 for ensuring a particular arrangement of the fibres in the final pultrudate. Between the cross-head die 1 and the haul-off device 3 is a water cooling arrangement as represented by numeral 5 in the drawings. In the process, polymer melt is supplied to the cross-head die 1 as referenced by arrow 6 so that as a result of the illustrated process the fibres become embedded in a matrix of the polymer thus producing the final pultrudate. The pultrusion process may be the Granex process (see, for example, S F Bush, ‘Long glass Fibre Reinforcement of Thermoplastics’. Int. Polym. Proc. (1999) 14 (3) 282-290).

In producing pultrudates in accordance with the invention, certain of the fibres 2 will be heat shrinkable fibres whereas others may be “retaining fibres”. Particular examples of arrangements of heat shrinkable fibres and “retaining fibres” are described below in the Examples.

### REFERENCE EXAMPLE 1

The heat shrink characteristics of low or non-oil surface PET fibres (Code No 3467-34) (1000 tex) were investigated by heating the fibres to 170° C. under various load conditions. More particularly, the shrinkage characteristics were investigated without any load and also with loads of 5, 10, 15, 20 and 25 g being supported by the fibres. The results were as shown in FIG. 2. It can be seen from FIG. 2 that, without any load, the PET fibres gave approximately 40% shrinkage on heating at 170° C. As can also be seen from FIG. 2, shrinkage decreased generally in inverse proportion to the increase in load.

The results illustrated in FIG. 2 provide an indication of the extent to which the PET fibres will be able to cause a change in shape (by thermoforming) of a composite in which they are incorporated.

### EXAMPLE 1

Various pultrudates were produced using the techniques described above in relation to FIG 1. The various compositions of the pultrudates are shown in Table 1. The matrices used were polypropylene, either Novolen 1100L (Targor) having MFI=6.0 or Hostalen (Hoechst) having MFI=0.1. Reinforcements include E-glass (600 tex), cotton sample 1 (190 tex) (available as crochet cotton from V & A Spinning Co. Bradford. UK), cotton sample 2 (500 tex) and PET (1000 tex). A proprietary coupling agent was incorporated except in the case of the samples marked with an asterisk

| | | | | | Number of | | |
|---|---|---|---|---|---|---|---|
| Sample | | Die | Diam./Section | | strands | | Fibre |
| no. | Matrix | Shape | (mm) | Fibre 1 | Fibre 1 | Fibre 2 | Vol % |
| 1 | Hostalen | Round | 3 | | | | |
| 2* | Hostalen | Round | 2.9 | Glass | 2 | | 8.6 |
| 3 | 1100L | Round | 4 | Glass | 4 | | 17.2 |
| 4 | Hostalen | Round | 3.5 | Cotton 2 | 2 | | — |
| 5 | Hostalen | Round | 3 | Cotton 1 | 2 | | — |
| 6* | Hostalen | Round | 3 | Cotton 1 | 3 | | 5.9 |
| 7 | Hostalen | Round | 3 | Cotton 1 | 3 | | 4.0 |
| 8 | Hostalen | Round | 3 | Cotton 1 | 4 | | 4.1 |
| 9 | 1100L | Round | 4 | Cotton 1 | 4 | | — |
| 10 | 1100L | Round | 4 | Cotton 1 | 4 | | — |
| 11 | Hostalen | Round | 3.2 | Cotton 1 | 5 | | 7.3 |
| 12 | 1100L | Square | 3.0 × 2.6 | | | PET | 11.0 |
| 13 | 1100L | Square | 2.8 × 3.4 | Cotton 1 | 1 | PET | 12.4 |
| 14 | 1100L | Square | 3.9 × 3.2 | Cotton 1 | 2 | PET | 14.3 |
| 15 | 1100L | Square | 4.5 × 3.8 | Cotton 1 | 4 | PET | 15.1 |
| 16 | 1100L | Square | 3.4 × 2.0 | Cotton 1 | 5 | PET | — |
| 17 | 1100L | Round | 4 | Cotton 1 | 5 | PET | 14.0 |

In the above Table 1, Sample Nos. 1-11 are comparative in that they do not incorporate heat shrinkable fibres. Samples 12-17 do incorporate such fibres and are in accordance with the invention.

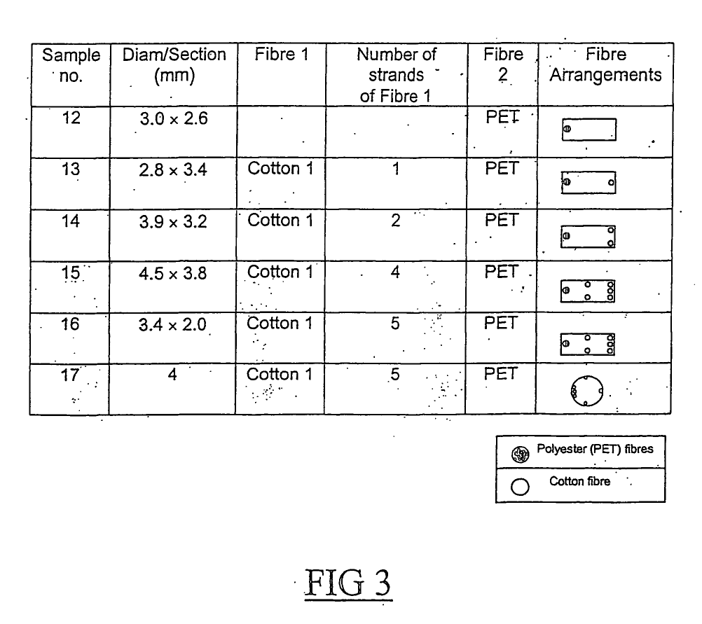

The particular fibre arrangement employed in each of Samples Nos. 12-17 is illustrated in FIG. 3 from which it will be noted that for the Samples 12-16 the heat shrinkable PET) fibres were located adjacent an edge of a retangular cross-section of the pultrudate with, In the case of samples 13-16, cotton reinforcing fibres being provided along at least one other edge. In the case of sample 17, which was of circular cross-section, the PET fibres were provided just inwardly of the circumferential edge of the cross-sect on with cotton reinforcing fibres being disposed at approximately 90° 180° and 270° around the circumference relative to the PET fibres.

Pultrudates as described above were subjected to a number of tests.

Test 1—Self Forming of Pultrudates

The self-thermoforming characteristics of Sample 16 (which has the polyester fibres running along the left-hand side of the cross-section, three cotton fibres running along the right-hand side and two additional cotton fibres located on the top and bottom of the section to add stability and stiffness to the pultrudate) were investigated by heating a 20 cm length of the pultrudate to a temperature of 170° C. for a time of 180 seconds.

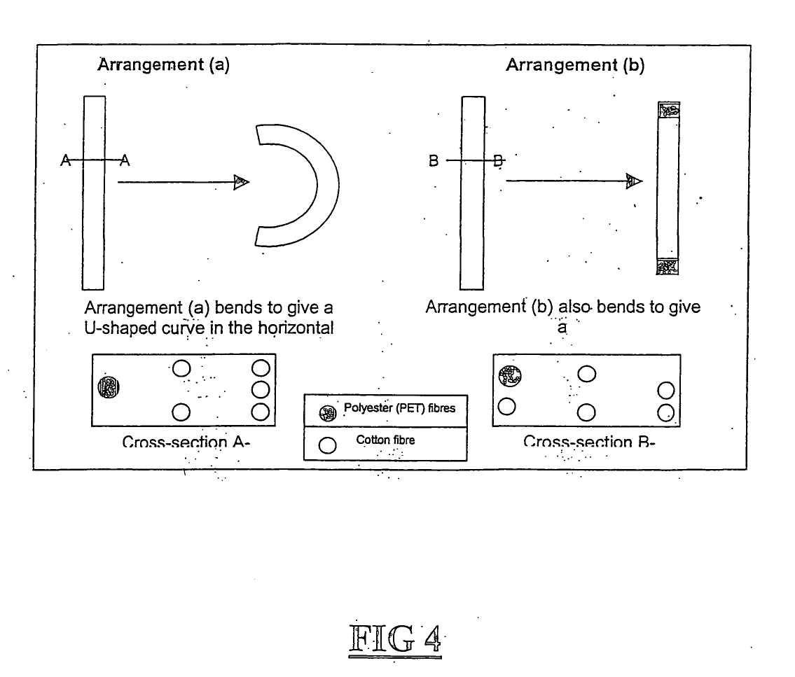

On heating the pultrudate (Sample 16) formed a semi-circle with the polyester fibre running along the inside edge of the semi-circle, i.e. the left-hand edge as illustrated in (a) of FIG. 4.

A modified version of Sample 16 was produced. In this modification, illustrated as arrangement (b) in FIG. 4, the only difference from Sample No. 16 was that one cotton fibre was relocated from the right-hand side to run directly alongside the polyester fibre. On heating, this modified pultrudate still deformed into a semi-circle but in a plane at right angles to that of arrangement (a), i.e. a single cotton thread ran along the inside edge of the semi-circle.

Test 2—Effect of Temperature and rime on Thermoforming

20 cm lengths of various pultrudates (and modifications thereof) from Table 1 were heated for different temperatures and times and then allowed to cool to room temperature. The distance, d, between the two ends of the generally arcuate (e.g. semi-circular) forms that resulted were then measured.

(i) FIG. 5 shows the results obtained for Sample 16 (square cross-section) and Sample 17 which was of round (rather than square) cross-section for heating at temperatures of 150° 160° 170° and 180° C. for a fixed time of 270 s.

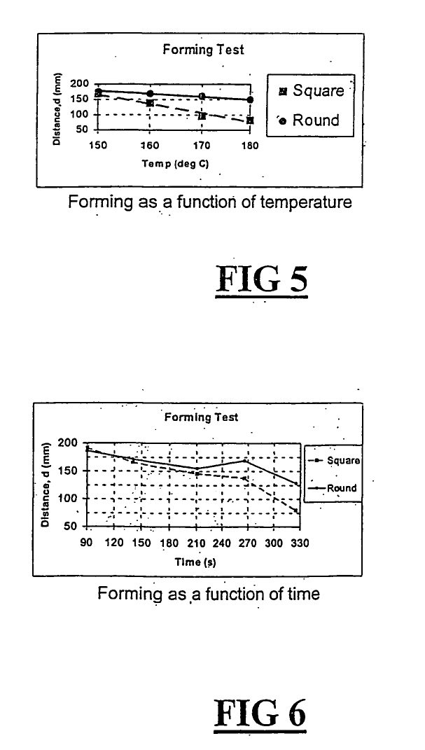

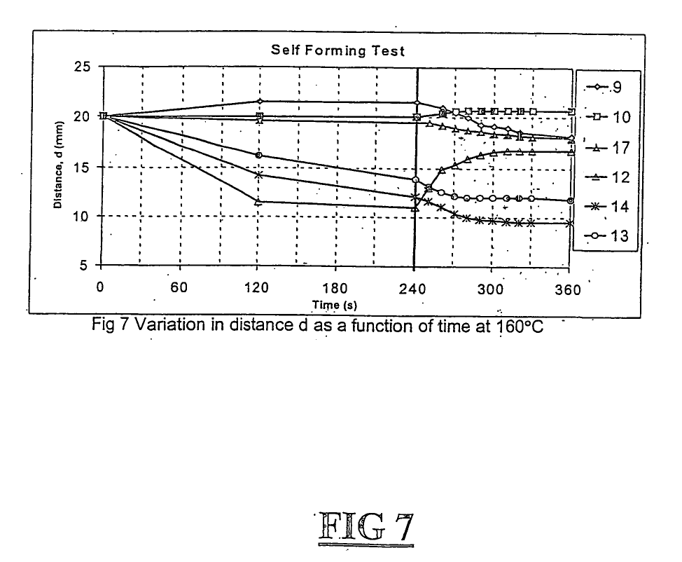

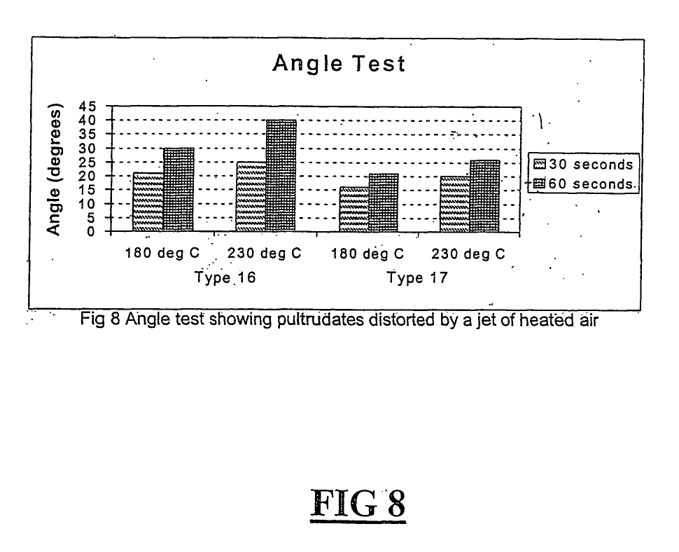

(ii) Samples 16 and 17 were investigated by monitoring the variation in d with time at a fixed temperature of 160° C. The results are shown in FIG. 6.

Test 3—Self Forming Test

70 cm lengths of Samples 9 and 10 were mechanically bent around so that the distance, d, between their ends was 20 mm. Similar lengths of Samples 12-13 and 17 were self-thermally formed by heating so that the distance, d, was 20 mm. All Samples were then placed in an oven that had been preheated to 160° C. The distance, d, was recorded at intervals of 60, 120, 180 and 240 seconds after the samples had been placed in the oven. After 240 seconds the samples were removed and left to cool on the bench and the distance, d, was measured at intervals over a period of 120 seconds.

The results are shown in FIG. 7.

It can be seen that, during the period of heating in the oven (i.e. up to the vertical black line in FIG. 7) samples Nos. 12-14 self-thermally formed so as to cause a significant reduction in the value of d. After removal from the oven, the distance, d, for Samples 13 and 14 continued to reduce whereas that for Sample No. 12 started to increase. This difference in behaviour was attributed at least partly to the fact that Samples Nos. 13 and 14 contained cotton as “retaining fibres” which inhibit reversion of the pultrudate back to its original form on cooling. In contrast Sample No. 12 contains only PET fibres which do allow some reversion of the pultrudate back to its original form on cooling.

It will be noted that there was no substantial change in the distance, d, in the case of Sample 17. This was attributed to the fact that the arrangement of cotton fibres as incorporated therein caused the shape resulting from the original self-thermally forming operation (i.e. that effected to bring the ends to 20 mm from each other) to be retained even during the subsequent heating in the oven at 160° C.

Samples Nos. 9 and 10 which contain only cotton, (and no PET fibres) did not exhibit any reduction in the distance d and, in fact, there was a small increase for Sample No 9

Test 4—Effect of Localised Heating

Samples Nos. 16 and 17 were subjected to localised heating by playing a jet of hot air at a Temperature of 180° C. at just one point. The angles generated in the Samples at the times of 30 seconds and 60 seconds were measured.

The test was repeated but using a jet of hot air at a temperature of 230° C.

The results are shown in FIG. 8 and demonstrate the angle the pultrudate bends round to can be controlled by varying the temperature of the air and the heating time.

Test 5—Apparent Stiffness

The apparent stiffness of a shaped pultrudates was measured using sample nos 2, 3, 6-8 and 11-17 which had been configured into a semi-circular specimen of radius 45 mm. In the case of the non-forming pultrudates, the sample was bent into this configuration. The samples of the self-forming pultrudates were heated so as to adopt the semi-circular configuration. For those pultrudates of rectangular cross-section one of the narrow sides was in the inside surface of the semi-circular form. A steel wire 2×1 mmn was also bent about its short side into semi-circular configuration and used for the purposes of this test.

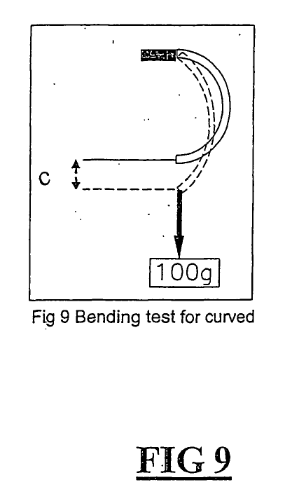

One end of the specimens was then firmly clamped so that the specimen adopted the configuration shown in FIG. 9 and the vertical distance between the two ends was measured. A weight of 100 g was then attached to the lower end of the specimen and after 30 minutes the vertical distance between the two ends of the specimen was remeasured. The difference, c, (see FIG. 9) was recorded. After this, the Weight was removed and the recovery of the specimen was also recorded.

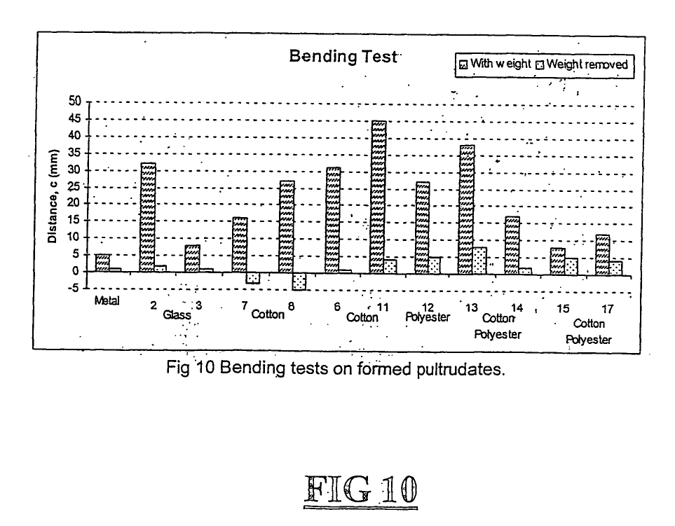

The results are shown in FIG. 10. The first result shown in FIG. 10 shows the deflection and recovery of the steel wire 2×1 mm bent about the short side. All the other results are from polypropylene fibre composites. Factors that influence the apparent stiffness of the samples include the fibre type, the number of reinforcing fibres, the polymer fibre interface, the size and shape of the pultrudate and the position of the reinforcing fibres within the cross-section. It can bee seen from FIG. 10 that the pultrudate of the invention recovered their shape after loading.

### EXAMPLE 2

Flat criss-cross structures were built up by fusing together an array of pultrudate elements under light pressure. Self-forming pultrudates (Sample 17) were laid in one direction and non-forming pultrudates (Sample 1) in another. The flat array was then heated in an oven where it formed into the cage shape shown in FIGS. 11 in which the dark lengths are the non-forming pultrudates (Sample 1) and the lighter lengths are the self-forming pultrudates (Sample 17).

The test was repeated but replacing the non-forming pultrudates by self-forming pultrudates (Sample 17) so that, in this case, the flat criss-cross structure comprised entirely of self-forming pultrudates. After heating the resulting cage structure was as shown in FIG. 14.

Although there is some distortion present in both cages, the results clearly show that systematic variation of the relative angles and spacings of the pultrudate elements provide a means of generating different cage shapes which should be difficult to generate economically in other ways.

1. A polymer composite comprised of a fibre or fibres in a polymer matrix wherein the or at least a portion of said fibres are heat shrinkable and is/are disposed within the matrix to render the composite self-thermally forming.

2. A composite as claimed in claim 1 wherein the heat shrinkable fibres are such that they shrink by at least 30% of their length when heated above the predetermined temperature.

3. A composite as claimed in claim 2 wherein the heat shrinkable fibres are such that they shrink by 30% to 60% of their length when heated above the predetermined temperature.

4. A composite as claimed in any one of claims 1 to 3 wherein the heat shrinkable fibres have an average cross-section of 500 to 1500 tex for the fibres used.

5. A composite as claimed in any one of claims 1 to 4 wherein the heat shrinkable fibres are provided in the form of a tow.

6. A composite as claimed in any one of claims 1 to 5 wherein the predetermined temperature is in the range 40° to 250° C.

7. A composite as claimed in claim 6 wherein the predetermined temperature is in the range 100° C. to 200° C.

8. A composite as claimed in any one of claims 1 to 7 wherein the heat shrinkable fibres are polyester fibres.

9. A composite as claimed in claim 8 wherein the heat shrinkable fibres are polyethylene terephthalate fibres.

10. A composite as claimed in any one of claims 1 to 9 incorporating a plurality of different types of heat shrinkable fibres for which shrinkage occurs at different temperatures.

11. A composite as claimed in any one of claims 1 to 12 additionally incorporating fibres (“retaining fibres”) which exhibit no or less shrinkage on heating above the predetermined temperature than do the heat shrinkable fibres.

12. A composite as claimed in claim 11 wherein the “retaining fibres” have a Youngs Modulus of 3 to 80 GPa.

13. A composite as claimed in claim 12 wherein the “retaining fibres” have a Youngs Modulus of 20 to 40 GPa.

14. A composite as claimed in any one of claims 11 to 13 wherein the “retaining fibres” have an average cross-section of 150 to 1000 tex for the fibres used.

15. A composite as claimed in any one of claims 11 to 14 wherein the “retaining fibres” are textile fibres of natural or synthetic origin, carbon fibres, aramid fibres, polyolefin fibres or glass fibres.

16. A composite as claimed in any one of claims 1 to 15 incorporating 1% to 60% by volume of fibres.

17. A composite as claimed in claim 16 incorporating 5% to 20% by volume of fibres.

18. A composite as claimed in any one of claims 1 to 17 wherein the polymer matrix comprises a polyolefin.

19. A composite as claimed in claim 18 wherein the polymer matrix comprises polypropylene.

20. A composite as claimed in any one of claims 1 to 19 wherein the polymer matrix incorporates a coupling agent.

21. A composite as claimed in any one of claims 1 to 20 wherein the cross-section of the composite is configured so as to enhance the extent to which the composite changes shape on self-thermal forming.

22. A composite as claimed in any one of claims 1 to 21 which is in the form of an elongate article with the heat shrinkable fibres being offset from the axial centre line of the article.

23. A composite as claimed in claim 22 wherein the elongate article is of polygonal cross-section.

24. A composite as claimed in claim 23 wherein heat shrinkable fibres are provided at or just inwardly of a side of the polygonal cross-section.

25. A composite as claimed in claim 24 wherein “retaining fibres” are provided at or just inwardly of another side of the polygonal cross-section.

26. A composite as claimed in claim 24 or 25 wherein the cross-section is triangular, square or rectangular.

27. A composite as claimed in claim 26 wherein the cross-section is rectangular and the heat shrinkable fibres are provided inwardly of the short-side of the rectangular cross-section.

28. A composite as claimed in claim 27 wherein “retaining fibres” are provided inwardly of the other short side of the rectangular cross-section.

29. A composite as claimed in claim 27 or 28 wherein “retaining fibres” are provided inwardly of the long side of the rectangular cross-section.

30. A composite as claimed in claim 22 wherein the elongate article is of circular, elliptical or oval cross-section.

31. A composite as claimed in claim 30 wherein the heat shrinkable fibres are provided just at or just inwardly of the circumference of the cross-section.

32. A composite as claimed in claim 31 wherein “retaining fibres” are provided at at least one other location at or just inwardly of the circumference.

33. A composite as claimed in any one of claims 22 to 32 wherein the elongate article is a pultrudate.

34. A composite as claimed in any one of claims 1 to 20 which is in the form of a sheet or plate with the heat shrinkable fibres being provided closer to one major face of the sheet than the other.

35. A method of forming a shaped product comprising heating a polymer composite comprised of a polymer matrix incorporating at least one heat shrinkable fibre disposed within the matrix so as to render the composite self-thermally forming, said heating being effected in at least a region of set composite so that the composite self-thermally forms to produce the shaped product.

36. A method as claimed in claim 35 wherein the composite is as claimed in any one of claims 2 to 19.

37. A method as claimed in claim 35 or 36 wherein the cross-section of the composite is configured so as to enhance the extent to which the composite changes shape on self-thermal forming.

38. A method as claimed in any one of claims 35 to 37 which is in the form of an elongate article with the heat shrinkable fibres being offset from the axial centre line of the article.

39. A method as claimed in claim 38 wherein the elongate article is of polygonal cross-section.

40. A method as claimed in claim 39 wherein heat shrinkable fibres are provided at or just inwardly of a side of the polygonal cross-section.

41. A method as claimed in claim 40 wherein “retaining fibres” are provided at or just inwardly of another side of the polygonal cross-section.

42. A method as claimed in claim 40 or 41 wherein the cross-section is triangular, square or rectangular.

43. A method as claimed in claim 41 wherein the cross-section is rectangular and the heat shrinkable fibres are provided inwardly of the short-side of the rectangular cross-section.

44. A method as claimed in claim 43 wherein “retaining fibres” are provided inwardly of the other short side of the rectangular cross-section.

45. A method as claimed in claim 43 or 44 wherein “retaining fibres” are provided inwardly of the long side of the rectangular cross-section.

46. A method as claimed in claim 38 wherein the elongate article is of circular, elliptical or oval cross-section.

47. A method as claimed in claim 45 wherein the heat shrinkable fibres are provided just at or just inwardly of the circumference of the cross-section.

48. A method as claimed in claim 47 wherein “retaining fibres” are provided at at least one other location at or just inwardly of the circumference.

49. A method as claimed in any one of claims 47 to 48 wherein the elongate article is a pultrudate.

50. A Method as claimed in any one of claims 35 to 37 wherein the composite is in the form of a sheet or plate with the heat shrinkable fibres being provided closer to one major phase of the sheet or plate than the other.

51. A method as claimed in any one of claims 35 to 50 wherein the composite incorporates a first type of heat shrinkable fibre for which shrinkage occurs at a first temperature and a second type of heat shrinkable fibre for which shrinkage occurs at a second, higher temperature, the method comprising heating at least a region of the composite to the first temperature to cause a first change in shape configuration and subsequently heating at least a region of the composite to the second temperature to cause a second change to occur.

52. A method as claimed in any one of claims 35 to 51 which comprises assembling a plurality of the self-thermally forming composites into a particular configuration and heating the assembled configuration so that individual composites self-thermally form to provide the desired final product.

53. A method as claimed in claim 52 wherein said assembled configuration additionally includes materials that do not self-thermally form.

54. A method as claimed in claim 52 or 53 wherein the self-thermally forming composites are in the form of elongate articles and are laid in one direction and either further self-thermally forming articles, non-self thermally forming articles or a combination of such articles are laid in a cross-ways direction so as to produce a criss-cross arrangement as the assembled configuration.

55. A method as claimed in claim 54 wherein the final product is a cage-like structure.
